(19) United States
(12) Patent Application Publication
(10) Pub. No.: US 2011/0166717 A1
(43) Pub. Date: Jul. 7, 2011

(54) Real power control in wind farm

(75) Inventor: Akira Yasugi, Tokyo (JP)

(73) Assignee: MITSUBISHI HEAVY INDUSTRIES, LTD., Tokyo (JP)

(21) Appl. No.: 12/801,233

(22) Filed: May 28, 2010

(51) Int. Cl. G06F 1/26; H02P 9/04

(52) U.S. Cl. 700/287; 290/44

(57) ABSTRACT

A method is provided for controlling real powers supplied from a plurality of wind farms each provided with a plurality of wind turbine generators to the utility grid. The method includes: performing control for reducing real powers supplied from a plurality of wind farms to a utility grid, down to limit values set for the respective wind farms, in response to increase in a grid frequency of the utility grid; and increasing the real power supplied from a first wind farm out of the plurality of wind farms to the utility grid than the limit value set for the first wind farm when the real power actually supplied from a second wind farm out of the plurality of wind farms to the utility grid does not reach the limit value set for the second wind farm.

### BACKGROUND OF THE INVENTION

1. Field of the Invention

The present invention relates to a control system of a wind farm, and in particular, relates to a technique for real power control in a wind farm.

2. Description of the Related Art

Entrepreneurs running wind power generation business often set up a group of wind turbine generators (e.g. several tens of wind turbine generators) and supply electric power to the utility grid by using the group of wind turbine generators. In general, a facility where a group of wind turbine generators are provided is called wind farm. With the context of the need for promotion of utilization of renewable energy, the number of wind farms is more and more increasing.

The grid frequency is greatly affected by the balance between the real power supplied to the utility grid by various power-generating facilities, such as wind farms, and the real power consumed by users consuming the same, and it is therefore important for stabilization of the grid frequency in operating wind farms to stably supply the real power in accordance with the state of the utility grid. When the grid frequency is excessively increased, for example, each wind farm is required to supply reduced real power. In a currently-conducted typical operation of the utility grid, the operator of the utility grid monitors the grid frequency and makes a request to wind farms for real power limitation when detecting an excessive increase in the grid frequency. Each wind farm performs real power limitation in response to this request.

One problem is that real power generated by wind power generation is essentially unstable since wind conditions change at all times. In order to overcome unstableness of wind power generation and cause each wind farm to supply required real power, various techniques have been proposed.

For example, International Publication WO2009/078072 A1 discloses a technique for reducing output variations at an interconnection point where a wind farm and the utility grid are connected. In this technique, the correlation between output variations of adjacent wind turbine generators is obtained, and the phase of the output variation of one of the wind turbine generators is controlled in response to the correlation between the output variations.

U.S. Patent Application Publication US 2009/0055030 A1 discloses a technique for dealing with unforeseen situations of the utility grid and allowing increase of real power if necessary. In this technique, the number of wind turbine generators which operate in a real power observer mode and the number of wind turbine generators which operate in a real power reserve mode are decided so that a real power reserve setpoint is satisfied.

Furthermore, International Publication WO2004/059814 A1 discloses a technique for stably supplying requested real power by using an electric energy storing unit.

According to a study of the inventor, however, these techniques leave room for improvement in terms of real power control of the whole utility grid.

### SUMMARY OF THE INVENTION

According to the study of the inventor, overall control of a plurality of wind farms is effective for purposes of optimization of real power control of the whole utility grid.

In an aspect of the present invention, a method is provided for controlling real powers supplied from a plurality of wind farms each provided with a plurality of wind turbine generators to the utility grid. The method includes: performing limitation control for reducing real powers supplied from a plurality of wind farms to a utility grid, to limit values set for the respective wind farms, in response to increase in a grid frequency of the utility grid; and increasing the real power supplied from a first wind farm out of the plurality of wind farms to the utility grid than the limit value set for the first wind farm when the real power actually supplied from a second wind farm out of the plurality of wind farms to the utility grid does not reach the limit value set for the second wind farm.

When the plurality of wind farms are provided with wind farm controllers for controlling the plurality of wind turbine generators, respectively, and the wind farm controllers provided in the plurality of wind farms are connected so as to be communicatable with each other, the step of increasing real power supplied from the first wind farm to the utility grid preferably includes detecting by the wind farm controller provided in the first wind farm that the real power actually supplied from the second wind farm to the utility grid does not reach the limit value set for the second wind farm on the basis of data received from the wind farm controller provided in the second wind farm.

In this case, it is preferable that the data which the first wind farm controller provided in the first wind farm receives from the wind farm controller provided in the second wind farm should include output deficiency data generated on the basis of the real power actually supplied from the second wind farm to the utility grid and the limit value set for the second wind farm.

In one embodiment, it is preferable that the step of reducing the real powers supplied from the plurality of wind farms to the utility grid includes: monitoring the grid frequency by a grid operator, and sending real power limiting requests which indicate wind farm controllers to reduce the real powers supplied from the plurality of wind farms to the utility grid down to the limit values, by a grid operator in response to increase in the grid frequency of the utility grid.

In one embodiment, the plurality of wind turbine generators provided in each of the plurality of wind farms are connected to a common interconnection point provided on the utility grid.

In one embodiment, the plurality of wind farms are each provided with a wind farm controller for controlling the plurality of wind turbine generators, and the step of reducing the real powers supplied from the plurality of wind farms to the utility grid includes: monitoring of the grid frequency by a grid operator; and sending real power limiting requests for instructing the wind farm controllers to reduce the real powers supplied from the plurality of wind farms to the utility grid down to limit values by a grid operator in response to increase in the grid frequency of the utility grid. In this case, it is preferable that the step of increasing the real power supplied from the first wind farm to the utility grid include: sending wind farm condition data indicative of the real Powers supplied from the plurality of wind farms to the utility grid and wind conditions of the plurality of wind farms, from the wind farm controllers to the grid operator; and instructing the wind controller provided in the first wind farm to increase the real power supplied from the first wind farm to the utility grid than the limit value set for the first wind farm by the grid operator, when the real power actually supplied from the second wind farm to the utility grid does not reach the limit value set for the second wind farm.

In a case where the number of wind farms is three and above, it is preferable that, when the real power actually supplied from the second wind farm to the utility grid does not reach the limit value set for the second wind farm, a greatest real power wind farm is selected as the first wind farm, the greatest real power wind farm having the greatest real power supplied to the utility grid at a timing immediately before the limitation control is started among the wind farms other than the second wind farm.

In another aspect of the present invention, a wind turbine generator system has a plurality of wind farms and an upper control system configured to control real powers supplied from the plurality of wind farms to the utility grid. In each of the plurality of wind farms, a plurality of wind turbine generators are provided. The upper control system performs control to reduce the real powers supplied from first and second wind farms among the plurality of wind farms to the utility grid, down to first and second limit values respectively, in response to increase in the grid frequency of the utility grid. The upper control system increases the real power supplied from the first wind farm to the utility grid than the first limit value when the real power actually supplied from the second wind farm to the utility grid does not reach the second limit value.

In one embodiment, the upper control system has a first wind farm controller for controlling a plurality of wind turbine generators provided in a first wind farm, and a second wind farm controller for controlling a plurality of wind turbine generators provided in a second wind farm, the first and second wind farm controllers being connected so as to be communicatable with each other. In this case, it is preferable that the first wind farm controller should detect that the real power actually supplied from the second wind farm to the utility grid does not reach the second limit value on the basis of data received from the second wind farm controller. In this case, it is preferable that the data which the first wind farm controller provided in the first wind farm receives from the second wind farm controller include output deficiency data generated on the basis of the real power actually supplied from the second wind farm to the utility grid, and the second limit value.

In one embodiment, the wind turbine generator system further has a grid operator which monitors the grid frequency. In this case, the grid operator, in response to increase in the grid frequency of the utility grid, sends real power limiting requests which instruct first and second wind farm controllers to reduce the real powers supplied from first and second wind farms to the utility grid, to first and second limit values, respectively.

In one embodiment, the plurality of first wind turbine generators are connected in common to a first interconnection point provided on the utility grid, and the plurality of second wind turbine generators are connected in common to a second interconnection point provided in the utility grid.

In one embodiment, the upper control system is provided with: a first wind farm controller for controlling the plurality of wind turbine generators provided in the first wind farm, a second wind farm controller for controlling the plurality of wind turbine generators provided in the second wind farm and a grid operator for monitoring the grid frequency; and the grid operator, in response to increase in the grid frequency of the utility grid, sends real power limiting requests which instruct the first and second wind farm controllers to reduce the real powers supplied from the wind farms to the utility grid, to the limit values respectively. In this case, it is preferable that the first wind farm controller sends first wind farm condition data indicative of the real power supplied from the first wind farm to the utility grid and wind conditions of the first wind farm, to the grid operator, the second wind farm controller sends second wind farm condition data indicative of the real power supplied from the second wind farm to the utility grid and wind conditions of the second wind farm, to the grid operator, and the grid operator instructs the first wind farm controller to increase the real power supplied from the first wind farm to the utility grid than the first limit value when the real power actually supplied from the second wind farm to the utility grid does not reach the second limit value.

In a case where the number of wind farms is three or more, it is preferable that the upper control system selects a greatest real power wind farm as the first wind farm, when the real power actually supplied from the second wind farm to the utility grid does not reach the limit value set for the second wind farm, the greatest real power wind farm having the greatest real power supplied to the utility grid at a timing immediately before the limitation control is started among the plurality of wind farms other than the second wind farm.

In still another aspect of the present invention, a wind farm controller has a data input interface for receiving state data indicating states of a plurality of wind turbine generators provided in a first wind farm, and a processor for controlling the plurality of wind turbine generators. Upon reception of a real power limiting request, the processor performs real power control for reducing the real power supplied from the first wind farm to the utility grid, down to a first limit value specified in the real power limiting request. The processor controls the plurality of wind turbine generators so as to increase the real power supplied from the first wind farm to the utility grid than the first limit value when detecting that the real power actually supplied from a second wind farm to the utility grid does not reach a second limit value specified for the second wind farm, during the real power control.

### BRIEF DESCRIPTION OF THE DRAWINGS

FIG. 1 is a block diagram showing the structure of a wind turbine generator system in one embodiment of the present invention;

FIG. 2 is a block diagram showing real power control in one embodiment;

FIG. 3 is a graph showing an example of real power limitation in each wind farm;

FIG. 4 is a block diagram showing the structure and operation of a wind farm controller;

FIG. 5 is a block diagram showing another structure of a wind turbine generator system in this embodiment; and

FIG. 6 is a block diagram describing real power control in another embodiment.

### DESCRIPTION OF THE PREFERRED EMBODIMENTS

Preferred embodiments of the present invention will be described below with reference to the attached drawings.

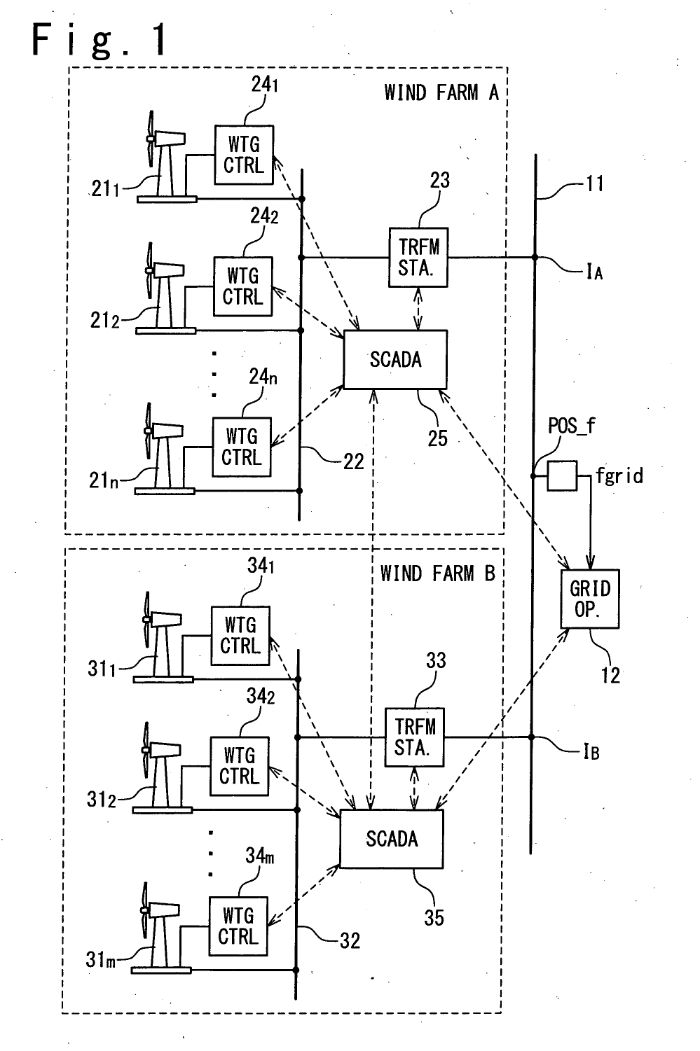

FIG. 1 is a block diagram showing the structure of a wind turbine generator system in one embodiment of the present invention. A plurality of wind farms, wind farms A and B in this embodiment, are connected to the utility grid 11. The wind farms A and B are connected to interconnection points I_{A} and I_{B} defined on the utility grid 11, respectively.

A grid operator 12 is provided in order to properly operate the utility grid 11. The grid operator 12, which is a utility grid operator, monitors the frequency of the utility grid 11 (hereinafter, referred to “grid frequency f_{grid}”) and sends real power command values necessary for the wind farms A and B in response to the grid frequency f_{grid}.

The wind farms A, B and the grid operator 12 may not be necessarily connected to the same power transmission line, although FIG. 1 shows the structure where the wind farms A and B are connected to the same power transmission line and the grid operator 12 monitors the grid frequency f_{grid} of the power transmission line. It should be noted, however, that the grid frequency f_{grid} is substantially the same at a position POS_f where the grid operator 12 monitors the grid frequency f_{grid}, and the interconnection points I_{A} and I_{B}, as long as the position POS_f and the interconnection points I_{A} and I_{B} are at the same power transmission network.

In the wind farm A, a plurality of wind turbine generators 21₁ to 21ₙ, an in-site power transmission line 22, a substation 23, WTG (wind turbine generator) controlling units 24₁ to 24ₙ, and a wind farm controller 25 (e.g. SCADA (Supervisory Control And Data Acquisition) are provided. Electric power generated by the wind turbine generators 21₁ to 21ₙ is sent to the substation 23 through the in-site power transmission line 22. The substation 23 performs voltage conversion, hence enabling the interconnection between the in-site power transmission line 22 and the utility grid 11. The WTG controlling units 24₁ to 24ₙ control the wind turbine generators 21₁ to 21ₙ, respectively. The wind farm controller 25 is a controller for performing overall monitoring and control of real power of the wind farm A, and controls the WTG controlling units 24₁ to 24ₙ and the substation 23. The wind farm controller 25 individually monitors the wind turbine generators 21₁ to 21ₙ and exchanges monitoring control signals with utility grid monitoring facility (not shown).

In the same way, a plurality of wind turbine generators 31₁ to 31ₙ an in-site power transmission line 32, a substation 33, WTG controlling units 34₁ to 34ₘ, and a wind farm controller 35 are provided in the wind farm B.

The grid operator 12, the wind farm. controllers 25 and 35, the WTG controlling units 24₁ to 24ₙ and 34₁ to 34ₘ constitute a hierarchical real power controlling system. More in detail, the WTG controlling units 24₁ to 24ₙ and 34₁ to 34ₘ operate as lower level controllers directly controlling the wind turbine generators 21₁ to 21ₙ and 31₁ to 31ₘ, and the grid operator 12 and the wind farm controllers 25 and 35 operate as upper level control systems. The grid operator 12 and the wind farm controllers 25 and 35 are connected through communication lines. In addition, the wind farm controllers 25 and 35 are also connected with each other through a communication line. In this embodiment, as will be described in detail later, the wind farm controllers 25 and 35 provided in the wind farms A and B are connected so as to be communicatable with each other and perform real power control together.

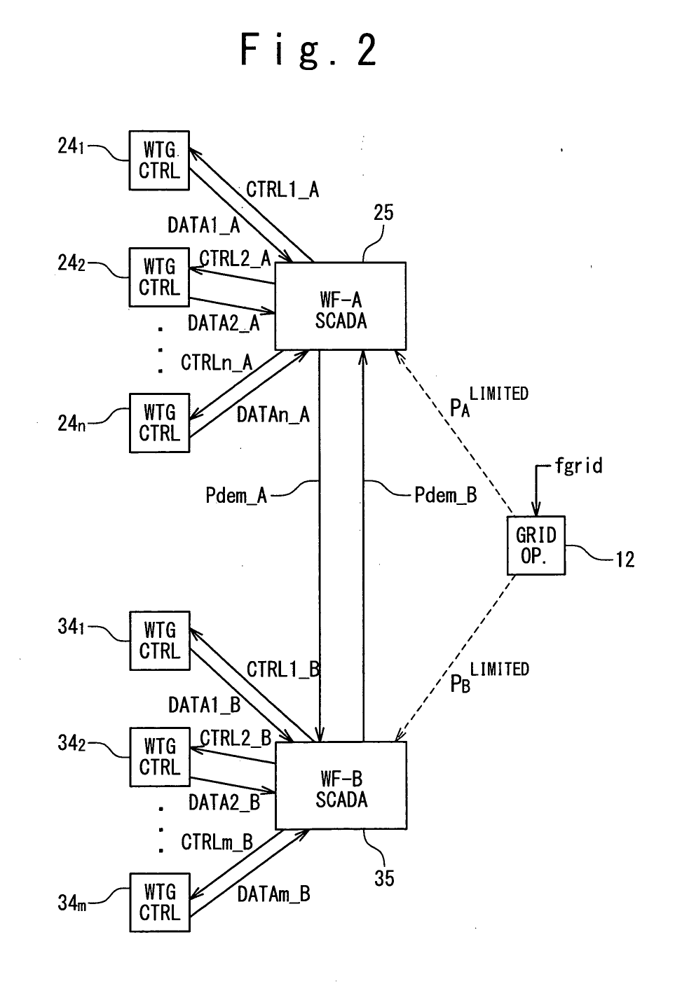

The real power controlling system thus constructed performs real power control with the following operation. FIG. 2 is a block diagram showing real power control in this embodiment.

The wind farm controller 25 provided in the wind farm A basically controls the wind turbine generators 21₁ to 21ₙ and the substation 23 so that real power supplied from the wind farm A to the utility grid 11 is adjusted to rated real power P_{A}^{RATED} of the wind farm A. More in detail, the wind farm controller 25 generates control commands CTRL1_A to CTRLn_A in response to SCADA data DATA1_A to DATAn_A received from the WTG controlling units 24₁ to 24ₙ, and supplies the control commands CTRL1_A to CTRLn_A to the WTG controlling units 24₁ to 24ₙ, respectively. Here, the SCADA data DATA1_A to DATAn_A are the data indicating the states of the wind turbine generators 21₁ to 21ₙ, respectively, and include measured values of the real powers actually outputted from the wind turbine generators 21₁ to 21ₙ and measured values of the wind speeds at the heights of the respective nacelles of the wind turbine generators 21₁ to 21ₙ. On the other hand, the control commands CTRL1_A to CTRLn_A include command values of the real powers of the wind turbine generators 21₁ to 21ₙ, respectively. The WTG controlling units 24₁ to 24ₙ control the real powers of the wind turbine generators 21₁ to 21ₙ in response to the control commands CTRL1_A to CTRLn_A. The real powers of the wind turbine generators 21₁ to 21ₙ are controlled so that the real power supplied from the wind farm A to the utility grid 11 is adjusted to the rated real power P_{A}^{RATED}.

In the same way, the wind farm controller 35 provided in the wind farm B basically controls the wind turbine generators 31₁ to 31ₘ and the substation 33 so that the real power supplied from the wind farm B to the utility grid 11 is adjusted to rated real power P_{B}^{RATED} of the wind farm B. More in detail, the wind farm controller 35 generates control commands CTRL1_B to CTRLm_B in response to SCADA data DATA1_B to DATAm_B received from the WTG controlling units 34₁ to 34ₘ, and supplies the control commands CTRL1_B to CTRLm_B to the WTG controlling units 34₁ to 34ₘ, respectively. Here, the SCADA data DATA1_B to DATAm_B are data indicating the states of the wind turbine generators 31₁ to 31ₘ, respectively, and include measured values of the real powers actually outputted by the wind turbine generators 31₁ to 31ₘ and measured values of the wind speeds at the heights of the respective nacelles of the wind turbine generators 31₁ to 31ₘ. On the other hand, the control commands CTRL1_B to CTRLm_B include command values of real powers of the wind turbine generators 31₁ to 31ₘ, respectively. The WTG controlling units 34₁ to 34ₘcontrol the real powers of the wind turbine generators 31₁ to 31ₘ in response to the control commands CTRL1_B to CTRLm_B. The real powers of the wind turbine generators 31₁ to 31ₘ are controlled so that real power supplied from the wind farm B to the utility grid 11 is adjusted to the rated real power P_{B}^{RATED}.

On the other hand, the grid operator 12 monitors and controls the grid frequency f_{grid}. More in detail, the grid operator 12, when detecting excessive increase in the grid frequency f_{grid}, sends real power limiting requests to the wind farm controllers 25 and 35 provided in the wind farms A and B. In the real power limiting requests, limit values P_{A}^{LIMITED} and P_{B}^{LIMITED} of the real powers of the wind farms A and B, respectively, are specified. The limit values P_{A}^{LIMITED} and P_{B}^{LIMITED} are smaller than the rated real power P_{A}^{RATED and P}_{B}^{RATED}, respectively.

In the wind farms A and B, real power limitation is performed in response to the real power limiting requests received from the grid operator 12. More in detail, in the wind farm A, the wind farm controllers 25 limits the real power outputted by at least one of the wind turbine generators 21₁ to 21ₙ to an output limit value. The output limit value may be a predetermined value (e.g. 20% of the real power currently outputted by the wind farm A), or may be decided by the wind farm controller 25. Such control allows limiting the real power supplied from the wind farm A to the utility grid 11 to the limit value P_{A}^{LIMITED}. In the same way, the wind farm controller 35 limits the real power outputted by at least one of the wind turbine generators 31₁-31ₘ to an output limit value in the wind farm B. The output limit value may be a predetermined value (e.g. 20% of real power currently outputted by the wind farm B), or may be decided by the wind farm controller 35. With the above-described control, the real power supplied from the wind farm B to the utility grid 11 is limited to the limit value P_{B}^{LIMITED}.

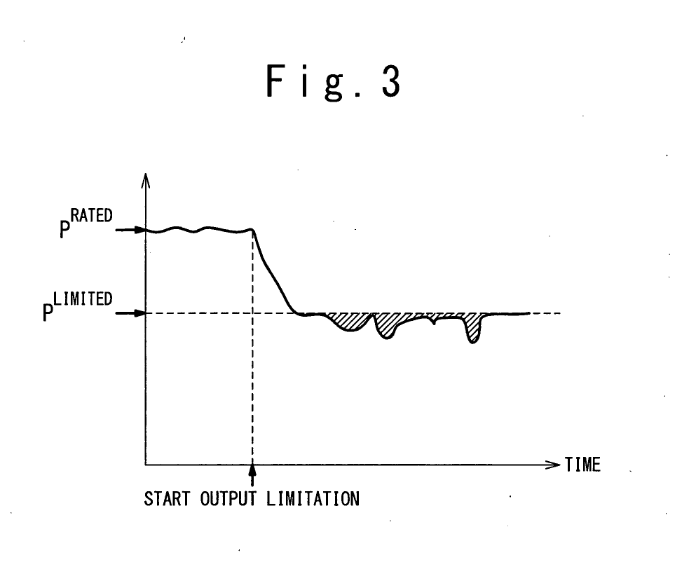

FIG. 3 is a graph showing an example of real power limitation implemented in each wind farm. When a real power limiting request is sent to each wind farm conducting normal operation, the real power supplied by each wind farm is reduced from the rated real power to a limit value specified by the real power limiting request. Consequently, excessive increase in the grid frequency is prevented.

Here, the real power actually supplied from each wind farm to the utility grid 11 may decrease below the specified limit value, depending on wind conditions. In FIG. 3, the supply deficiency of the real power supply is indicated by hatching. The supply deficiency of the real power causes a fall in the grid frequency and is not preferable in terms of the grid frequency control.

In order to address this, the real power controlling system performs real power control in this embodiment so that the supply deficiency of the real power is compensated in a case where each wind farm performs real power limitation. More in detail, each wind farm controller monitors occurrence of deficiency of real power in another wind farm, while the real power limitation is performed in each wind farm. A wind farm controller which has detected occurrence of deficiency of real power in another wind farm increases the real power supplied by the wind farm where that wind farm controller is provided above the corresponding limit value in order to compensate for the supply deficiency of the real power.

Detailed description will be given below concerning the real power control when each wind farm performs real power limitation. The wind farm controller 35 provided in the wind farm B receives output deficiency data Pdem_A from the wind farm controller 25 provided in the wind farm A. Here, the output deficiency data Pdem_A are data indicating whether or not supply deficiency of the real power of the wind farm A occurs. In one embodiment, the output deficiency data Pdem_A is calculated as the remainder after subtracting real power P_{S}_{_{—}}_{A} actually supplied from the wind farm A to the utility grid 11, from the limit value P_{A}^{LIMITED}. That is to say,

Pdem_{—}A=P_{A}^{LIMITED}−P_{S}_{_{—}}_{A}.

The wind farm controller 35, when detecting occurrence of supply deficiency of the real power of the wind farm A from the output deficiency data Pdem_A, increases the real power supplied from the wind farm B to the utility grid 11 than the control value P_{B}^{LIMITED}, and controls the wind turbine generators 31₁ to 31ₘ so as to compensate for the output deficiency.

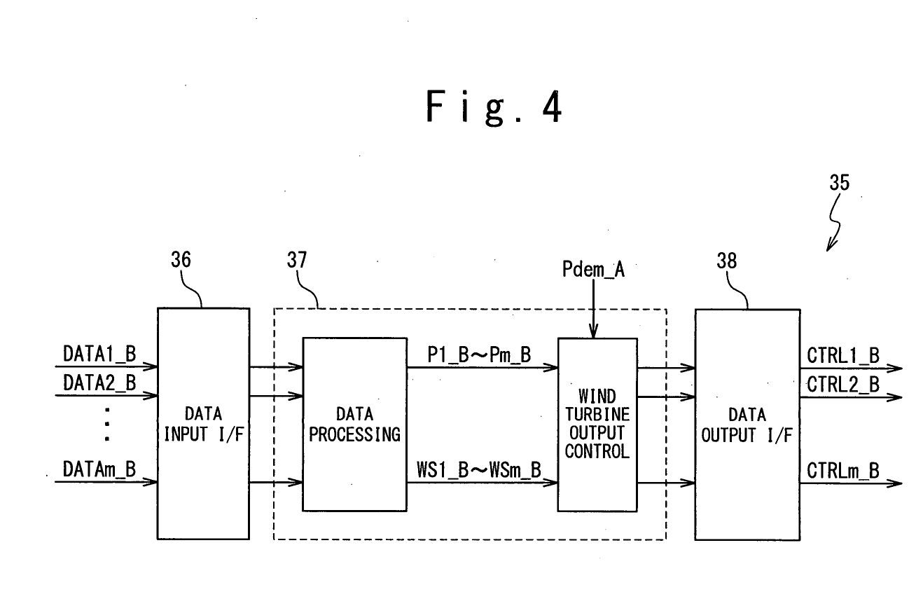

FIG. 4 is a block diagram showing real power control performed in the wind farm controller 35 of the wind farm B. The wind farm controller 35 includes a data input interface 36, a processor 37, and a data output interface 38. Although the processor 37 is shown as a group of functional blocks, this does not mean that each functional block is always formed as hardware. The data input interface 36 receives SCADA data DATA1_B to DATAm_B from the WTG controlling units 34₁ to 34m. The processor 37 generates the control commands CTRL1_B to CTRLm_B in response to the SCADA data DATA1_B to DATAm_B, the real power limiting request received from the grid operator 12, and the output deficiency data Pdem_A of the wind farm A. The data output interface 38 sends the control commands CTR1_B to CTRm_B, to the WTG controlling units 34₁ to 34ₘ.

The processor 37 operates as follows: The processor 37 performs data processing for extracting the real power P1_B to Pm_B actually outputted by the wind turbine generators 31₁ to 31ₘ, respectively, and the wind speeds WS1_B to WSm_B of the wind turbine generators 31₁ to 31ₘ, from the SCADA data DATA1_B to DATAm_B. Furthermore, the processor 37 controls the real powers outputted by the wind turbine generators 31₁ to 31ₘ on the basis of the real power P1_B to Pm_B, the wind speeds WS1_B to WSm_B, and the output deficiency data Pdem_A of the wind farm A. More in detail, the processor 37 invalidates the output limitation concerning at least one wind turbine generator out of the wind turbine generators in which the output real power is limited, or increases the output limit value concerning the wind turbine generator, when judging it possible from the real power P1_B to Pm_B and the wind speeds WS1_B to WSm_B. The processor 37 generates the control commands CTRL1_B to CTRLm_B for controlling the wind turbine generators 31₁ to 31ₘ in the above way. The control commands CTRL1_B to CTRLm_B are sent to the WTG controlling units 34₁ to 34m. With the above operation, the wind farm controller 35 increases the real power supplied from the wind farm B to the utility grid 11.

In the same way, the wind farm controller 25 receives output deficiency data Pdem_B from the wind farm controller 35 provided in the wind farm B, and controls the wind turbine generators 21₁ to 21ₙ so as to increase the real power supplied from the wind farm A to the utility grid 11 when detecting occurrence of supply deficiency of the real power of the wind farm B from the output deficiency data Pdem_B.

As described above, the wind farm controllers 25 and 35 provided in the wind farms A and B operate in cooperation with each other, and when supply deficiency of real power occurs in one wind farm, real power supplied by the other wind farm is increased, in this embodiment. This allows compensating for supply deficiency of the real power to the utility grid 11 and stabilizing the grid frequency f_{grid}.

An advantage of the wind turbine generator system of this embodiment is that the wind farms A and B are under the overall control and thereby the occurrence of supply deficiency of real power to the utility grid 11 and destabilization of the grid frequency due to the foregoing are effectively prevented. Even when supply deficiency of the real power occurs due to changes in wind conditions in one wind farm, another wind farm compensates for the supply deficiency, in this embodiment. As described above, the wind turbine generator system of this embodiment can compensate for supply deficiency of the real power which cannot be prevented by individual control of the wind farms.

Although the configuration in which the two wind farms A and B are connected to the utility grid 11 are described above, the number of wind farms is not limited to two and maybe three and above. In this case, wind farm controllers each provided in the wind farms are connected so as to be communicatable with one another. A wind farm controller of a wind farm increases the supply of the real power of the wind farm where the wind farm controller is provided, when detecting supply deficiency of real power in at least one wind farm among other wind farms.

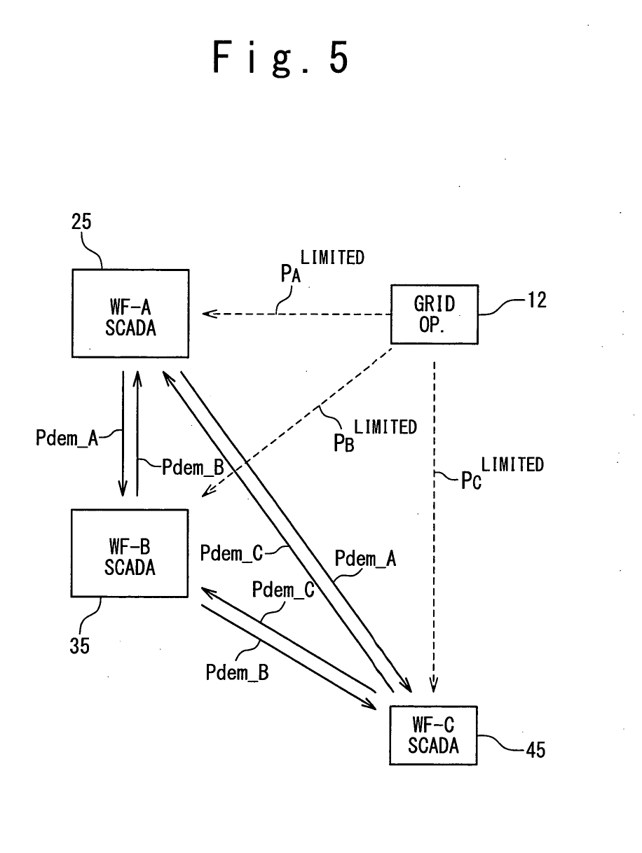

For example, FIG. 5 schematically shows the structure of a wind turbine generator system when three wind farms A, B, and C are provided. In a case where the number of wind farms is three and above, when supply deficiency of real power is caused in a wind farm, a control may be performed for preferentially increasing supply of real power of a wind farm that outputs the greatest real power immediately before the real power limitation of each wind farm is started (namely, immediately before the grid operator 12 sends real power limiting requests to the wind farm controllers 25, 35, and 45 provided in the wind farms A, B, and C) among the other wind farms. For example, consider a case where supply deficiency of real power is caused in the wind farm A after the grid operator 12 sends real power limiting requests to the wind farm controllers 25, 35, and 45 provided in the wind farm A, B, and C respectively. In this case, the real power supplied by the wind farm B is increased to compensate for the output deficiency when the real power outputted by the wind farm B immediately before the real power limiting request is sent is greater than that of the wind farm C. When such a control method is employed, the respective wind farm controllers 25, 35, and 45 of the respective wind farms are formed to monitor the real powers of the other wind farms.

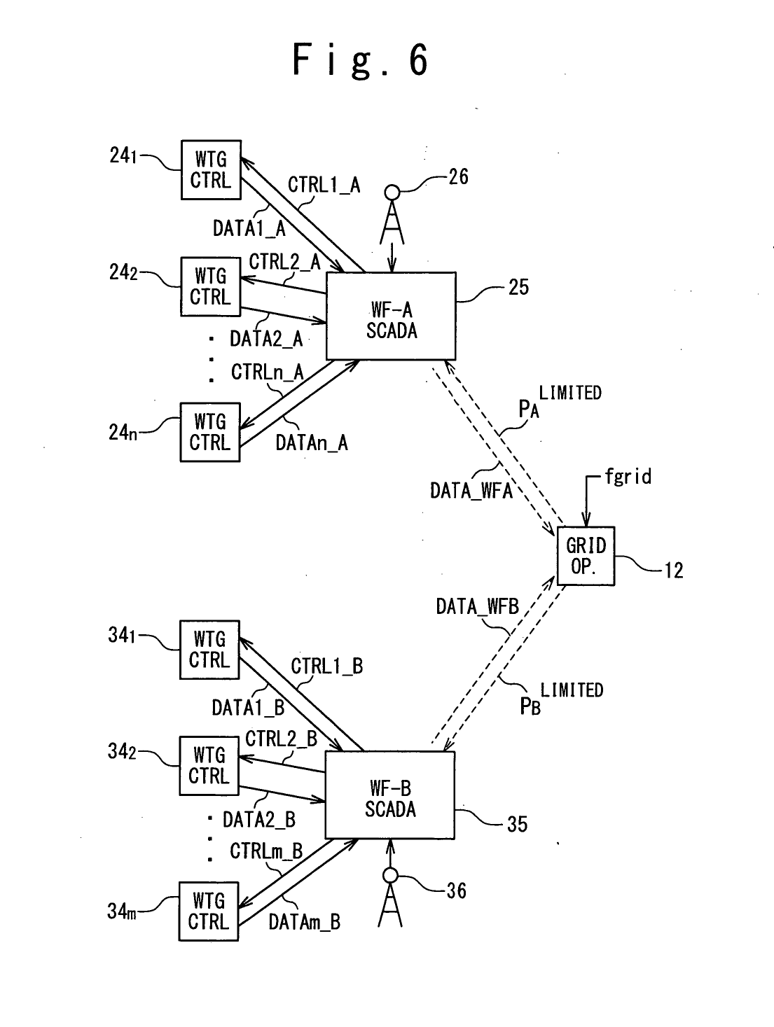

FIG. 6 is a block diagram showing the configuration of a real power controlling system in another embodiment of the present invention. In the configuration of FIG. 6, the grid operator 12 functions as an uppermost controller for conducting overall control of wind farms A and B.

In the structure of FIG. 6, the wind farm A is provided with an observation mast 26 for observing wind conditions of the wind farm A, and the wind farm B is provided with an observation mast 36 for observing wind conditions of the wind farm B. The wind farm controller 25 sends wind farm condition data DATA_WFA indicating conditions of the wind farm A to the grid operator 12. Here, the wind farm condition data DATA_WFA describe wind conditions of the wind farm A observed by the observation mast 26 and the real power actually supplied from the wind farm A to the utility grid 11.

In the same way, the wind farm controller 35 sends wind farm condition data DATA_WFB indicating conditions of the wind farm B to the grid operator 12. Here, the wind farm condition data DATA_WFB describes wind conditions of the wind farm B observed by the observation mast 36 and the real power actually supplied from the wind farm B to the utility grid 11.

In the same way as the above-mentioned embodiments, the grid operator 12 monitors and controls the grid frequency f_{grid}. The grid operator 12, when detecting excessive increase in the grid frequency f_{grid}, sends real power limiting requests to the wind farm controllers 25 and 35 provided in the wind farms A and B. In the real power limiting requests, respective limit values P_{A}^{LIMITED} and P_{B}^{LIMITED} of the real powers of the wind farms A and B are specified. In the wind farms A and B, real power limitation is performed by the wind farm controllers 25 and 35 in response to the real power limiting requests sent from the grid operator 12.

In addition, the grid operator 12, when detecting supply deficiency of real power in either wind farm from the wind farm condition data DATA_WFA and DATA_WFB, provides the wind controller 25 or the wind controller 35 with instructions to increase the real power which the other wind farm supplies. More in detail, the grid operator 12, when detecting occurrence of supply deficiency of the real power in the wind farm A from the wind farm condition data DATA_WFA and the limit value P_{A}^{LIMITED} of real power of the wind farm A, provides the wind farm controller 35 with instructions to increase the real power supplied from the wind farm B to the utility grid 11 than the limit value P_{B}^{LIMITED}. The wind farm controller 35 controls the wind turbine generators 31₁ to 31ₘ so as to increase the real power supplied from the wind farm B to the utility grid 11.

In the same way, the grid operator 12, when detecting occurrence of supply deficiency of real power in the wind farm B from the wind farm condition data DATA_WFB and the limit value P_{B}^{LIMITED} of real power of the wind farm B, provides the wind farm controller 25 with instructions to increase the real power supplied from the wind farm A to the utility grid 11 than the limit value P_{A}^{LIMITED} The wind farm controller 25 controls the wind turbine generators 21₁ to 21ₙ so as to increase the real power supplied from the wind farm A to the utility grid 11.

In this embodiment as described above, the wind farms A and B are under the overall supervision of the grid operator 12, and when supply deficiency of real power occurs in one wind farm, real power supplied by the other wind farm is increased. This allows compensating for supply deficiency of real power to the utility grid 11 and stabilizes the grid frequency f_{grid}. Also in this embodiment, when supply deficiency of real power occurs due to change in wind conditions in one wind farm, the supply deficiency is compensated for by the other wind farm; the wind turbine generator system of this embodiment allows compensating for supply deficiency of the real power which cannot be prevented by individual controls of wind farms.

Although the embodiments of the present invent ion have been described in detail above, it would be apparent to those skilled in the art that the present invention is not limited to the above-mentioned embodiments and various changes may be made without departing from the technical scope of the present invention.

In the structure of FIG. 5 for example, the wind farm controllers 25 and 35 may inform the grid operator 12 of wind conditions observed at each of the wind turbine generators 21₁ to 21ₙ and 31₁ to 31ₘ through the wind farm condition data DATA_WFA and DATA_WFB, instead of wind conditions observed by the observation masts 26 and 36.

1. A method of controlling real powers supplied to a utility grid from a plurality of wind farms in each of which a Plurality of wind turbine generators are provided, said method comprising:
performing limitation control to reduce respective real powers supplied from said plurality of wind farms to said utility grid, to limit values set for said plurality of wind farms, respectively, in response to an increase in a grid frequency of said utility grid; and
increasing real power supplied from a first wind farm out of said plurality of wind farms to said utility grid than a limit value set for said first wind farm, when real power actually supplied from a second wind farm out of said plurality of wind farms to said utility grid does not reach a limit value set for said second wind farm.

2. The method according to claim 1, wherein said plurality of wind farms are each provided with a wind farm controller for controlling said plurality of wind turbine generators,
wherein said controllers are connected so as to be communicatable with each other, and
wherein said increasing the real power supplied from said first wind farm to said utility grid includes: by said controller provided in said first wind farm, detecting that the real power actually supplied from said second wind farm to said utility grid does not reach the limit value set for said second wind farm, based on data received from said controller provided in the second wind farm.

3. The method according to claim 2, wherein said data received from said controller provided in said second wind farm include output deficiency data generated based on the real power actually supplied from said second wind farm to said utility grid and said limit value set for said second wind farm.

4. The method according to claim 2, wherein said reducing the real powers supplied from said plurality of wind farms to said utility grid includes:
monitoring said grid frequency by a grid operator; and
sending real power limiting requests to said controllers by said grid operator in response to an increase in the grid frequency of said utility grid, said real power limiting requests requesting to reduce the real powers supplied from said plurality of wind farms to said utility grid.

5. The method according to claim 1, wherein said plurality of wind turbine generators provided in each of said plurality of wind farms are connected to a common interconnection point defined on said utility grid.

6. The method according to claim 1,
wherein said plurality of wind farms are respectively provided with controllers controlling said plurality of wind turbine generators,
wherein said reducing the real powers supplied from said plurality of wind farms to said utility grid includes:
monitoring said grid frequency by a grid operator; and
sending real power limiting requests to said controllers by said grid operator in response to an increase in the grid frequency of said utility grid, said real power limiting requests requesting to reduce the real powers supplied from said plurality of wind farms to said utility grid, and
wherein said increasing the real power supplied from said first wind farm to said utility grid includes:
sending wind farm condition data indicative of the real powers supplied from said plurality of wind farms to said utility grid and wind conditions of said plurality of wind farms, to said grid operator by said controllers; and
when the real power actually supplied from said second wind farm to said utility grid does not reach said limit value set for said second wind farm, instructing said controller provided in said first wind farm to increase the real power supplied from said first wind farm to said utility grid than said limit value set for said first wind farm, by said grid operator.

7. The method according to claim 1, wherein the number of said plurality of wind farms is three or more, and
wherein, when the real power actually supplied from said second wind farm to said utility grid does not reach said limit value set for said second wind farm, a maximum real power wind farm is selected as said first wind farm, said maximum real power wind farm having the greatest real power supplied to said utility grid at the moment immediately before said limitation control is started, among wind farms out of said plurality of wind farms other than said second wind farm.

8. A wind turbine generator system, comprising:
a plurality of wind farms each provided with a plurality of wind turbine generators; and
an upper control system configured to control real powers supplied from said respective wind farms to a utility grid,
wherein said upper control system performs limitation control to reduce real powers supplied from first and second wind farms out of said plurality of wind farms to said utility grid, to first and second limit values, respectively, in response to increase in a grid frequency of said utility grid, and
wherein said upper control system increases real power supplied from said first wind farm to said utility grid than said first limit value when real power actually supplied from said second wind farm to said utility grid does not reach said second limit value.

9. The wind turbine generator system according to claim 8, wherein said upper control system includes:
a first wind farm controller controlling the plurality of wind turbine generators provided in said first wind farm; and
a second wind farm controller controlling the plurality of wind turbine generators provided in said second wind farm,
wherein said first and second wind farm controllers are connected so as to be communicatable with each other, and
wherein said first wind farm controller detects that the real power actually supplied from said second wind farm to said utility grid does not reach said second limit value, based on data received from said second wind farm controller.

10. The wind turbine generator system according to claim 9, wherein said data received from said second wind farm controller include output deficiency data generated based on the real power actually supplied from said second wind farm to said utility grid and said second limit value.

11. The win d turbine generator system according to claim 9, further comprising:
a grid operator monitoring said grid frequency,
wherein said grid operator sends real power limiting requests to said first and second wind farm controller, said real power limiting requests requesting to reduce the real powers from said first and second wind farms to said utility grid to said first and second limit values, respectively.

12. The wind turbine generator system according to claim 8,
wherein said plurality of wind turbine generators provided in said first wind farm are commonly connected to a first interconnection point defined on said utility grid, and
wherein said plurality of wind turbine generators provided in said second wind farm are commonly connected to a second interconnection point defined on said utility grid.

13. The wind turbine generator system according to claim 8, wherein said upper control system includes:
a first wind farm controller controlling the plurality of wind turbine generators provided in said first wind farm;
a second wind farm controller controlling the plurality of wind turbine generators provided in said second wind farm; and
a grid operator monitoring said grid frequency,
wherein said grid operator sends real power limiting requests to said first and second wind farm controllers in response to an increase in the grid frequency of said utility grid, said real power limiting requests requesting to reduce the real powers supplied from said plurality of wind farms to said utility grid to said first and second limit values,
wherein said first wind farm controller sends first wind farm condition data indicating the real power supplied from said first wind farm to said utility grid and wind conditions of said wind farm, to said grid operator,
wherein said second wind farm controller sends second wind farm condition data indicating the real power supplied from said second wind farm to said utility grid and wind conditions of said wind farm, to said grid operator, and
wherein said grid operator instructs said first wind farm controller to increase the real power supplied from said first wind farm to said utility grid than said first limit value, when the real power actually supplied from said second wind farm to said utility grid does not reach said second limit value.

14. The wind turbine generator system according to claim 8, wherein the number of said plurality of wind farms is three or more, and
wherein said upper control system selects as said first wind farm a maximum real power wind farm having the greatest real power supplied to said utility grid at a moment immediately before said limitation control is started, among wind farms out of said plurality of wind farms other than said second wind farm, when the real power actually supplied from said second wind farm to said utility grid does not reach said second limit value set for said second wind farm.

15. A wind farm cont roller, comprising:
a data input interface receiving state data indicating states of a plurality of wind turbine generators provided in a first wind farm; and
a processor controlling said plurality of wind turbine generators,
wherein upon reception of a real power limiting request, said processor performs real power control which reduces real power supplied from said first wind farm to a utility grid to a first limit value indicated in said real power limiting request, and
wherein, when detecting that real power actually supplied from a second wind farm to said utility grid does not reach a second limit value set for said second wind farm in performing said real power control, said processor controls said plurality of wind turbine generators to increase the real power supplied from said first wind farm to said utility grid than said first limit value.
